(19) United States
(12) Patent Application Publication
(10) Pub. No.: US 2026/0006541 A1
(43) Pub. Date: Jan. 1, 2026

(54) SYSTEMS AND METHODS FOR SORTING WIRELESS NETWORKS

(71) Applicant: Adeia Guides Inc., San Jose, CA (US)

(72) Inventors: Serhad Doken, Bryn Mawr, PA (US); Charles Dasher, Lawrenceville, GA (US); Dhananjay Lal, Englewood, CO (US)

(21) Appl. No.: 18/756,415

(22) Filed: Jun. 27, 2024

(51) Int. Cl. H04W 48/18; H04W 28/08

(52) U.S. Cl. CPC H04W 48/18; H04W 28/0942

(57) ABSTRACT

Systems and methods are provided for sorting Wi-Fi networks. Network load information associated with each of a plurality of Wi-Fi networks is received at a computing device, and the received network load information is processed to determine a network load associated with each of the plurality of Wi-Fi networks. An application is selected at the computing device, and each Wi-Fi network of the plurality of Wi-Fi networks is ranked based on the determined network loads and the selected application. An ordered list of indicators for at least a subset of the plurality of Wi-Fi networks is generated for output and based on the ranking.

One or more disclosed embodiments are directed towards systems and methods for enabling the improved sorting of wireless networks, such as Wi-Fi networks. Some embodiments or aspects relate to additional or alternative features, functionalities, and/or fields.

### SUMMARY

With the availability of portable smart devices, such as smartphones, tablet devices, extended reality devices, and the like, there is an expectation that wireless internet connectivity is continuously available, usually in the form of cellular or Wi-Fi networks. Typically, a connection to a cellular network is handled by the smart device without any user interaction. Connecting to a new Wi-Fi network is usually a manual process, where a user picks a Wi-Fi network to connect to, and enters a password associated with the Wi-Fi network. Typical user interfaces usually provide minimal information about a Wi-Fi network, such as a name (also known as a service set identifier (SSID)) of a Wi-Fi network and a signal strength (such as in the form of a number of bars that represent signal strength). While this information provides some indication of how a Wi-Fi network may perform (e.g., a Wi-Fi network with a weak signal strength is likely to perform badly), it does not provide enough information to make an optimal or well-reasoned decision, especially in situations where multiple Wi-Fi networks are available and have similar signal strengths or signal strengths that may vary over time and/or vary based on proximity. A Wi-Fi network with a strong signal strength may appear to be an good choice; however, the Wi-Fi network may be congested (e.g., have lots of devices connected to it) and/or may comprise a relatively slow connection (e.g., it may have relatively low bandwidth available) to a wide area network, such as the internet. In another example, a Wi-Fi network may have a limit on the number of devices that can connect to it. From a typical user interface, a user cannot tell how congested a Wi-Fi network is, the available bandwidth of a connection to a wide area network and/or whether a limit on the number of devices that can connect to the Wi-Fi network has been reached.

To help address these problems, systems and methods are provided for enabling the improved sorting of wireless networks, such as Wi-Fi networks.

In accordance with a first aspect of the disclosure, a method is provided that includes receiving network load information associated with each of a plurality of Wi-Fi networks at a computing device, and processing the received network load information to determine a network load associated with each of the plurality of Wi-Fi networks. An application is selected at the computing device, and each Wi-Fi network of the plurality of Wi-Fi networks is ranked based on the determined network loads and the selected application. An ordered list of indicators for at least a subset of the plurality of Wi-Fi networks is generated for output based on the ranking.

In an example system, an input for connecting to a Wi-Fi network is received at a smartphone. The smartphone receives network load information, for example, at least one of a maximum number of connected devices, a current number of connected devices, a temporal channel loading, an available bit rate, a processor utilization, and/or memory utilization associated with Wi-Fi networks local to the smartphone. The smartphone processes the received network load information to determine the network load associated with each of the local Wi-Fi networks. In order to rank the Wi-Fi networks, an input is received, for example, at the smartphone selecting an OTT application, such as a Disney+ application, and the Wi-Fi networks are ranked based on the network load and the application. The ranking may include ranking the networks based on an appropriateness for use with the OTT application. The smartphone may, for example, prioritize a network with a relatively high available bandwidth over a network with a relatively low latency. Once the smartphone has ranked the Wi-Fi networks, a list of the Wi-Fi networks is, for example, displayed at the smartphone in a user interface for selecting a Wi-Fi network. In some examples, these rankings can be filtered further if a device, such as the aforementioned smartphone, has connected to that Wi-Fi network before and/or the ranking information can be generated for output during the ranking if a setting to automatically join a Wi-Fi network has not been enabled.

### BRIEF DESCRIPTIONS OF THE DRAWINGS

The present disclosure, in accordance with one or more various embodiments, is described in detail with reference to the following figures. The drawings are provided for purposes of illustration only and merely depict typical or example embodiments. These drawings are provided to facilitate an understanding of the concepts disclosed herein and shall not be considered limiting of the breadth, scope, or applicability of these concepts. It should be noted that for clarity and ease of illustration these drawings are not necessarily made to scale.

The above and other objects and advantages of the disclosure may be apparent upon consideration of the following detailed description, taken in conjunction with the accompanying drawings, in which:

FIG. 1 shows an example environment for enabling the improved sorting of Wi-Fi networks, in accordance with some embodiments of the disclosure;

FIG. 2 shows another example environment for enabling the improved sorting of Wi-Fi networks, in accordance with some embodiments of the disclosure;

FIG. 3A shows another example environment for enabling the improved sorting of Wi-Fi networks, in accordance with some embodiments of the disclosure;

FIG. 3B shows another example environment for enabling the improved sorting of Wi-Fi networks, in accordance with some embodiments of the disclosure;

FIG. 3C shows another example environment for enabling the improved sorting of Wi-Fi networks, in accordance with some embodiments of the disclosure;

FIG. 4 shows another example environment for enabling the improved sorting of Wi-Fi networks, in accordance with some embodiments of the disclosure;

FIG. 5 shows another example environment for enabling the improved sorting of Wi-Fi networks, in accordance with some embodiments of the disclosure;

FIG. 6 shows another example environment for enabling the improved sorting of Wi-Fi networks, in accordance with some embodiments of the disclosure;

FIG. 7 shows another example environment for enabling the improved sorting of Wi-Fi networks, in accordance with some embodiments of the disclosure;

FIG. 8 shows a flowchart of illustrative steps involved in enabling the improved sorting of Wi-Fi networks, in accordance with some embodiments of the disclosure;

FIG. 9 shows another flowchart of illustrative steps involved in enabling the improved sorting of Wi-Fi networks, in accordance with some embodiments of the disclosure;

FIG. 10 shows another flowchart of illustrative steps involved in enabling the improved sorting of Wi-Fi networks, in accordance with some embodiments of the disclosure; and

FIG. 11 shows a block diagram representing components of a computing device and dataflow therebetween for enabling the improved sorting of Wi-Fi networks, in accordance with some embodiments of the disclosure.

### DETAILED DESCRIPTION

A Wi-Fi network may comprise a Wi-Fi access point (AP) that is connected to a wide area network, such as the internet. In other examples, a Wi-Fi network may comprise a plurality of Wi-Fi APs, in some examples, all with the same SSID. In further examples, a Wi-Fi network may comprise any number of components downstream and/or integral to a Wi-Fi AP including, for example, one or more firewalls and/or load balancers.

Network load information may comprise any suitable information about a network. This information may comprise, for example, at least one of a maximum number of connected devices, a current number of connected devices, a temporal channel loading, an available bit rate, a processor utilization, and/or a memory utilization associated with Wi-Fi networks.

An application running on a computing device may have a network resource associated with it, which may specify one or more of a minimum resource requirement, or an optional, recommended, or optimal resource availability. A network resource associated with an application may relate to, for example, a requirement for a relatively high bandwidth, a relatively low latency, and/or a relatively uncongested network. Generally, applications are associated with network resources, and the disclosed techniques consider these network resources in sorting wireless networks. Applications may run in the foreground, background, in standby, and/or an application may not be running at the present time, for example, it may be in a sleep state, but the application may be expected and/or predicted to run at a future time. The disclosed techniques may consider these different application states and associated network resources in sorting the wireless networks. In some examples, an application, or applications, may be selected or considered for sorting wireless networks based on historic load at a computing device, for example, if an application that has a requirement for a relatively high bandwidth typically runs at the computing device then the networks may be sorted based on bandwidth. In an example, the application selection for sorting wireless networks may comprise an application running in the foreground, and an application running in the background such as, for example, YouTube running in the foreground and streaming content that is visible on a display, and Netflix running in the background without being actively used or visible but still performing tasks, such as downloading content. In this example, the wireless network sorting is based both on the streaming requirement of the YouTube application running in the foreground and the downloading content of the Netflix application running in the background. In some examples, a specific use for an application, such as a search query, may be prioritized over a general use, such as downloading a large file. In other examples, different application functionalities may be prioritized on a per-application basis, for example, paying a bill, downloading a menu, streaming a live sporting event or playing an online multiplayer game may be prioritized over downloading content for later viewing. In some examples, a first application, or first group of applications, may be prioritized with respect to a second application, or second group of applications. On identifying an application, or group of applications, or usage type to be prioritized, that application, or group of applications, or usage type may be used to help rank the wireless networks.

The disclosed methods and systems may be implemented on one or more devices, such as user or client devices, servers, network management or other network devices, and/or other computing devices. As referred to herein, the device can be any device comprising a processor and memory, for example, a handheld computer, a mobile telephone, a portable video player, a portable music player, a portable gaming machine, a smartphone, a smartwatch, a smart speaker, an augmented reality headset, a mixed reality device, a virtual reality device, a gaming console, vehicle infotainment headend or any other computing equipment, wireless device, a modem, a router, and/or combination of the same.

The methods and/or any instructions for performing any of the embodiments discussed herein may be encoded on computer-readable media. Computer-readable media includes any media capable of storing data. The computer-readable media may be transitory, including, but not limited to, propagating electrical or electromagnetic signals, or may be non-transitory, including, but not limited to, volatile and non-volatile computer memory or storage devices such as a hard disk, USB drive, DVD, CD, media cards, register memory, processor caches, random access memory (RAM) and/or a solid-state drive.

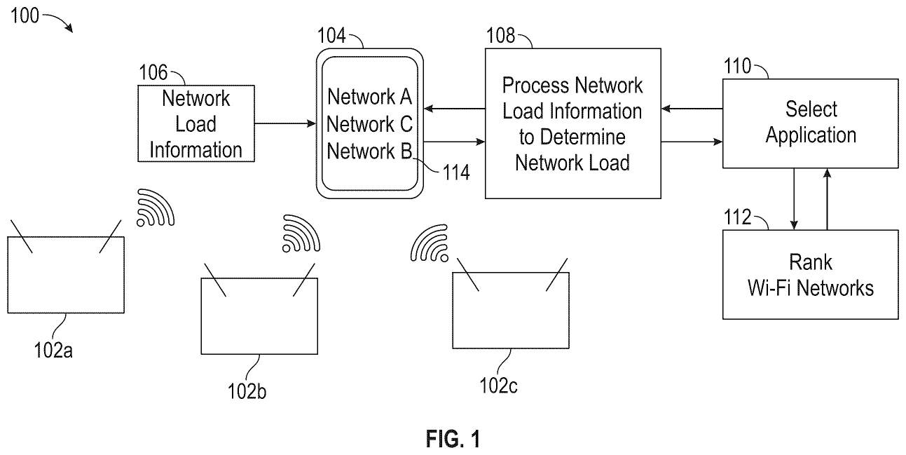

FIG. 1 shows an example environment for enabling the improved sorting of Wi-Fi networks, in accordance with some embodiments of the disclosure. The environment 100 comprises a plurality of Wi-Fi networks 102a-c and a computing device 104. In this example, only physical Wi-Fi APs are shown, but the Wi-Fi network may comprise any number of additional components. In this example, the computing device 104 is a smartphone, but the computing device may be any computing device that is configured to connect to a Wi-Fi network including, for example, a tablet device or a personal computer (PC). On scanning for Wi-Fi networks, the smartphone 104 will generally identify relatively close physical Wi-Fi APs via their respective broadcast SSIDs in a user interface.

The smartphone 104 receives 106 network load information associated with each of the Wi-Fi networks 102a-c. The smartphone 104 may receive this network load information when it scans for Wi-Fi networks, for example, in response to a received input and/or during an automated refresh of available Wi-Fi networks. Each AP may have network load information and an SSID associated with it, and the network load information may be associated with a received SSID of a Wi-Fi network. The network load information may comprise any suitable information about a network. This information may comprise, for example, at least one of a maximum number of connected devices, a current number of connected devices, a temporal channel loading, an available bit rate, a processor utilization and/or a memory utilization associated with Wi-Fi networks. In some examples, the network load information is received within a beacon management frame associated with a Wi-Fi network. A beacon management frame typically comprises information about a Wi-Fi network and is typically transmitted periodically by an AP. The smartphone processes 108 the received network load information to determine a load associated with each of the Wi-Fi networks 102a-c. In some examples, the network load information may indicate that a particular Wi-Fi network, for example, has a relatively low or high bandwidth available to it. In other examples, a Wi-Fi network may have a relatively low or high latency associated with it.

At 110, an application is selected. In some examples, this may be an application that is running on the smartphone 104, an application that is scheduled to run and/or or an application that is predicted to run on the smartphone. Predicting which application may run on the smartphone may take place via an analysis of historic running data. For example, historic running data may indicate that a particular application always runs at 19.00 on a weekday, for example, a Netflix application. In another example, a second application may usually run after a first application is closed. For example, a gaming application may usually run after a messaging application is closed. The selection of an application may comprise the selection of a single application, a group of applications, a group of related applications and/or a type of application. An application may itself provide distinct functionality, and wireless networks may be sorted, and/or ranked based on a selected in-use, or predicted, functionality of one or more applications. Network resource usage and/or requirements may be analyzed on a per-application function basis. An example of a single application is a Netflix application for streaming video on demand. Applications may be related by type, for example, over-the-top streaming applications, such as Netflix, Hulu and Disney+. In other examples, applications may be related by required network resource, for example, video conferencing applications such as Zoom and Teams that require a relatively low latency. In some examples, software running on the smartphone may select the application, or group of applications. In other examples, an application, or group of applications, may be selected via an input received at the smartphone.

At 112, the Wi-Fi networks are ranked based on the processed network load information and the selected application. For example, if an application that requires a relatively large amount of available bandwidth is selected, then available bandwidth may be used to rank the Wi-Fi networks. In other examples, multiple categories may be selected to order the Wi-Fi networks with, for example, a first category being prioritized over a second category. For example, the categories may be bandwidth and ping may be used to rank the Wi-Fi networks. In this example, bandwidth may be used to rank the Wi-Fi networks, and ping may be used as a secondary category for, for example, Wi-Fi networks that have the same, or similar, bandwidth. The ranked Wi-Fi networks are then generated for output 114, for example, for display at the smartphone 104. Taking into account network load information and a selected application(s) at the computing device enables Wi-Fi networks to be ranked in a manner that is tailored to the selected application(s) and hence leads to an improved ranking of the Wi-Fi networks when compared to systems that simply list Wi-Fi networks based on signal strength alone.

In order to generate network load information for transmission from an AP, an AP (or APs) associated with an SSID may compute its ability to serve new connections based on traffic conditions using one or more of the following parameters: maximum allowed client connections per an AP association table, number of current client connections that are presently associated with the AP, temporal channel loading; and/or cumulative bit rate available.

The maximum allowed client connections per the AP association table and the number of current client connections that are presently associated with the AP represent the headroom available at the AP to allow a new station (STA) or STAs to join the Wi-Fi network associated with the AP. A station is generally a Wi-Fi-enabled computing device. While channel loading and/or utilization may be a good measure to gauge how well an AP is deployed to serve data, the number of clients connected to the AP is also an important consideration, especially given that with orthogonal frequency-division multiple access (OFDMA) (Wi-Fi 6 and 7), an AP schedules multiple transmissions concurrently to STAs, and in another time slot, it also synchronously receives multiple transmissions from STAs. The greater the number of clients, the more complex the transmission and reception schedule.

The parameters of maximum allowed client connections per an AP association table and number of current client connections that are presently associated with the AP may be translated into a single value of total number of STAs that are allowed to join the AP by subtracting number of current client connections that are presently associated with the AP for maximum allowed client connections per an AP association table.

The parameter of temporal channel loading (TCL) represents the percentage of time for which the channel is deemed busy by the AP, and it may be calculated as follows:

$$TCL = \frac{\begin{matrix}Time spent in productive activities + \\ Time spent in unproductive activities\end{matrix}}{Total time}$$

In an example, the time spent in productive activities includes the time in active transmission or reception by the AP (which may also include time spent in unsuccessful transmissions and receptions including packet collisions). In an example, time spent in unproductive activities includes time in which the channel is deemed unusable, for example, waiting time when a received signal strength indicator (RSSI) is determined to be too high for an active communication (per, for example, a carrier sense multiple access with collision avoidance (CSMA/CA) mechanism). As a percentage, (100−temporal channel loading) this represents the time headroom available for transmission and reception for new STAs connected to the AP.

The parameter of cumulative bit rate available represents the theoretical maximum bit rate for new STAs that may be supported by an AP on a channel, or as an aggregate bit rate across multiple channels. To help determine the capacity and speed of a Wi-Fi network, the theoretical data rate of a channel for, for example, Wi-Fi 7 can be calculated. It is given by multiplying the number of data subcarriers, the bits per subcarrier symbol, the coding rate, and the number of spatial streams to get the total bits transmitted per OFDM symbol period. This product is then divided by the total time for one OFDM symbol, which includes both the DFT period and the guard interval, as shown below:

$$Data Rate = \frac{{N}_{SD , U} \times {N}_{BPSCS , U} \times R \times {N}_{SS}}{{T}_{DFT} + {T}_{GI}}$$

N_{SD,U} is the number of data subcarriers per resource unit, where a resource unit is a group of 78.125 kHz bandwidth subcarriers used in both downlink and uplink transmissions. The data subcarriers are individual carriers contained within a divided frequency band, with each carrier carrying a bit stream, and with N_{SD,U} referring to those carriers used for transmitting data. N_{BPSCS,U} is the number of coded bits per subcarrier per stream for the resource unit, which depends on the modulation scheme being used, with each modulation scheme encoding a different number of bits per symbol. R is the coding rate used by the error-correction code, which is a measure of the redundancy added for error correction and detection, and it is defined as the ratio of the data rate of the input data to the data rate of the output data. N_{SS} is the number of spatial streams being used, T_{DFT} is the orthogonal frequency-division multiplexing symbol duration and it is used for simplifying frequency domain operations, and T_{GI} is the guard interval duration, which is a period of time between symbols to prevent interference caused by multipath propagation delays.

The available bit rate in a channel may be calculated by measuring the noise level (in dB or dBm). The AP, for instance, may calculate a minimum signal-to-noise (SNR) ratio needed to support a successful communication (e.g., by a lookup table) by using the noise level in the channel (for example, derived from sampling received signal strength when there is no useful transmission via, for example, clear channel assessment (CCA)). The minimum SNR needed to support a successful communication may be translated into a maximum value of the modulation coding scheme (MCS) for the channel. This process may be typically performed for a group of resource units (RUs) that represent a channel (for example, the process may be performed individually for each RU and then accumulated across all the RUs). Then, the cumulative bit rate available (CBR) in a channel may be given by:

$$CBR = Theoretical bit rate ( based on MCS ) - Actual bit rate ( currently in use )$$

An STA may also monitor its radio environment (via CCA) to determine the noise level in its neighborhood. Based on the RSSI measured from an AP radio frequency (RF) beacon, the STA estimates an SNR, where:

$$SNR = RSSI of RF beacon ( dBm ) - Noise level ( dBm )$$

If the estimated SNR is greater than a threshold value, then the STA can infer that the cumulative bit rate available may be achieved, i.e., it represents an available capacity. On the other hand, if the estimated SNR is below the threshold value, then the STA may conclude that the RF propagation in the wireless link between AP and STA (i.e., the channel quality) is not good enough to achieve the cumulative bit rate available. In order to favor a channel/band for use, the STA may determine that the SNR calculated from the RF beacon of the AP is above the threshold value, and that the cumulative bit rate available exceeds the bit rate needs of the application.

Typically, an STA may be programmed or controlled to ensure that the cumulative bit rate available is above the bit rate needs of the application (for example, an order of magnitude higher). This may, for example, indicate that latency and jitter requirements of applications are also more likely to be met (albeit not guaranteed). Calculating that the SNR from the RF beacon of the AP is above a threshold enables the AP to check that the channel conditions between the STA and the AP are acceptable. Determining that the cumulative bit rate available exceeds the bit rate needs of the application enables the STA to check that the data rate needs of the application(s) can be met with headroom to spare.

The information about the ability of the AP to serve new connections based on the traffic conditions may be broadcast from the AP in beacon frames on a per RU basis, per channel basis, and/or as an aggregate across all channels. In some examples, the more granular this information, the greater the ability of an STA to determine the suitability of an AP for the communication needs of the STA (i.e., a Wi-Fi-enabled computing device).

In some examples, instead of transmitting actual values for some of the aforementioned parameters, such as temporal channel loading, and cumulative bit rate available, an AP may use a relatively coarse-grained measure such as high, medium or low. The translation of internally computed values to these coarse-grained measures may be based on a standard and/or computed in a proprietary manner by an AP.

The above-mentioned parameters are not limited to any specific name, formula and/or calculation. for determining the parameters In particular, determining the number of current client connections that are presently associated with the AP, and determining the cumulative bit rate available are not limited to any specific name, formula and/or calculation as long as a temporal utilization of a channel and/or a theoretical available capacity as a bit rate are advertised by the AP.

For an AP, or APs, representing an SSID, the load on its internal resource usage may be calculated using the following parameters: current CPU utilization of processor or packet co-processors and/or current memory usage. The dynamic load on the internal resources of an AP may depend on current conditions. For example, bandwidth optimization and OFDMA schedule determination may consume computation resources. Similarly, memory use may run high when a channel experiences adverse conditions (with a particular STA and/or across all STAs).

In some examples, in place of transmitting actual values for processor and/or co-processor utilization, or memory utilization, an AP may provide a relatively coarser measure such as high, medium or low. In some examples, in place of transmitting the values, an AP may transmit the total number of instances in a recent time window when the processor usage and/or the memory usage crossed a threshold value. In this example, the greater the absolute number of these parameters, the greater the loading on the internal resources of the AP.

An AP may communicate the capacity and load data within a beacon management frame that is being broadcast. This may be performed in a standardized way, or by a vendor AP transmitting the capacity and load data, and a vendor client (such as an application) that can read the intended format to interpret the capacity and load data.

Client computing devices that receive this beacon frame from all APs, or a sub set of APs may compare the capacity and load data with respect to a selected application or applications and/or any applications currently running on the client computing device. Table 1 below shows example beacon frame information received from several APs:

TABLE 1

| | | | | Cumulative | Processor | |
|---|---|---|---|---|---|---|
| | | | Temporal | Available | and/or Co- | |
| | Max | Current | Channel | bit rate | processor | Mem- |
| SSID | Clients | Clients | Loading | Mbps | Utilization | ory |
| Y | 25 | 20 | 25 | 55 | 80 | 60 |
| Cent | 25 | 2 | 5 | 25 | 20 | 40 |
| Grill | 50 | 12 | 40 | 65 | 30 | 40 |
| S | 20 | 10 | 30 | 5 | 40 | 20 |

Table 1 represents an example scenario wherein the parameters of temporal channel loading and cumulative bit rate available are presented as aggregates across all channels. These parameters may be presented on a per RU or on a per channel basis.

In some examples, there may be more than one application running on a computing device. Some applications may run in the foreground, and other applications may run in the background. The computing device may analyze the current application that is in the foreground, such as a video streaming application that is actively operating on the computing device, and is visible on the device and/or responsive to user input. In some examples, the most network resource-demanding application that is running on a computing device may be considered first. For example, a 60 fps cloud gaming client may require 40 Mbps of bandwidth. Thus, networks associated with SSIDs Y and Grill from Table 1 are the suitable candidates based on cumulative available bit rate, as they are both above 40 Mbps. However, the network Grill has greater headroom for clients, available bit rate, processor utilization and memory. Network Y has a relatively high processor utilization of 80. Thus, the gaming client running on the computing device may be better served by connecting to network Grill. Thus, the computing device may switch a preference to the Grill network for the streaming application. This process may be performed for all the applications, or a sub set of the applications, that are running on the device to determine an optimal network for the client as a whole. In other examples, the process may be performed for an application that is scheduled to run and/or or an application that is predicted to run. Predicting which application may run on the smartphone may take place via an analysis of historic running data. For example, historic running data may indicate that a particular application always runs at 19.00 on a weekday, for example, a Netflix application. In another example, a second application may usually run after a first application is closed. For example, a gaming application may usually run after a messaging application is closed.

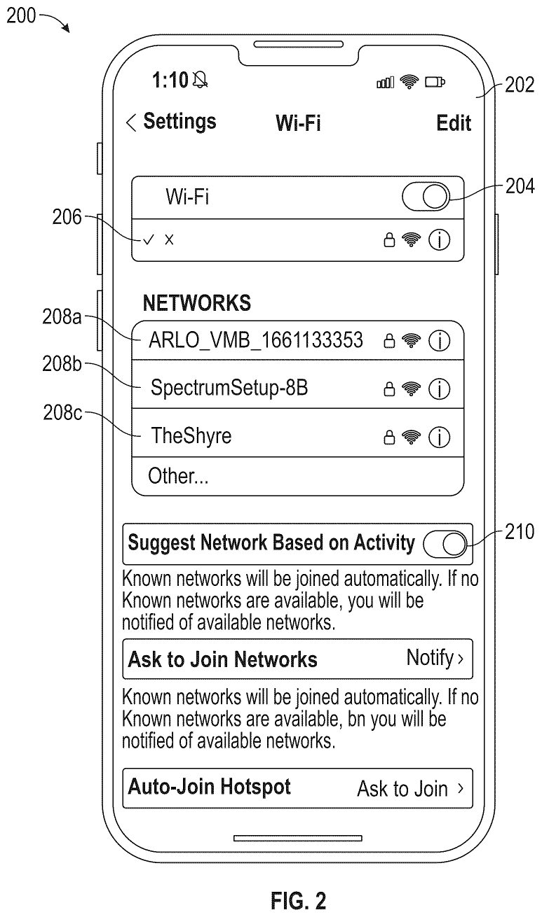

FIG. 2 shows another example environment for enabling the improved sorting of Wi-Fi networks, in accordance with some embodiments of the disclosure. The environment 200 comprises a graphical user interface (GUI) 202 for a computing device, such as a smartphone. The GUI 202 comprises a first user interface element 204 for turning a Wi-Fi connection on and off, and an indication 206 of the Wi-Fi network that the smartphone is connected to. In addition, the GUI 202 indicates other Wi-Fi networks 208a-c that are available for connecting to. The GUI 202 also comprises a second user interface element 210 for connecting to a Wi-Fi network based on activity, for example, based on an application. On setting the second user interface element 210 to on, the computing device may sort and reorganize the available Wi-Fi networks list by classifying which SSID is best for what activity.

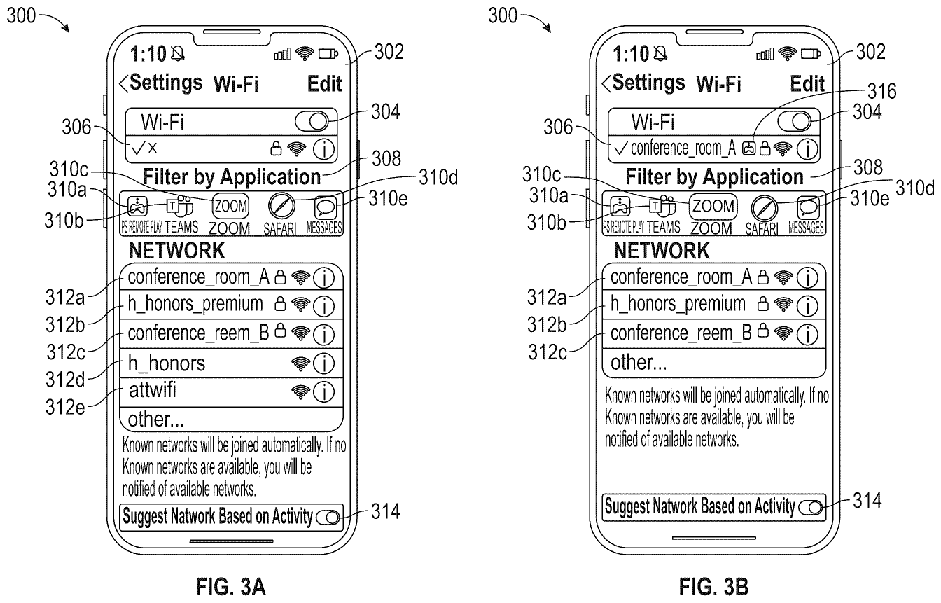

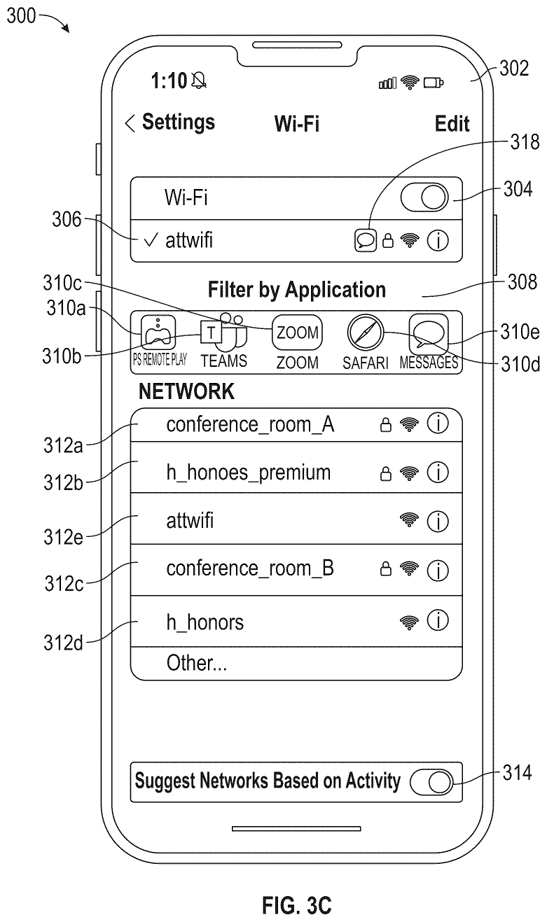

FIG. 3A shows another example environment for enabling the improved sorting of Wi-Fi networks, in accordance with some embodiments of the disclosure. The environment 300 comprises a GUI 302 for a computing device, such as a smartphone. The GUI 302 comprises a first user interface element 304 for turning a Wi-Fi connection on and off, and an indication 306 of the Wi-Fi network that the smartphone is connected to. In addition, the GUI 302 comprises a section 308 for filtering Wi-Fi networks by application. The section 308 comprises a plurality of user interface elements 310a-e that enable a user to select an application to filter the Wi-Fi networks by. The user interface elements 310a-e each comprise an icon associated with a different application. In this example, the applications are PS Remote Play 310a, Teams 310b, Zoom 310c, Safari 310d, and Messages 310e. Each application may have different, or the same, network resources associated with it. The GUI 302 also indicates other Wi-Fi networks 312a-e that are available for connecting to. The GUI 202 also comprises a second user interface element 314 for connecting to a Wi-Fi network based on activity, for example, based on an application. In this example, none of the applications 310a-e are selected, so the Wi-Fi networks 312a-e are sorted in a default order, for example, by Wi-Fi network signal strength. In some examples, selecting the “i” user interface element associated with a network 312a-c may cause additional information to be generated for display. This additional information may comprise one or more of a maximum allowed client connections; a number of current client connections; a temporal channel loading; and/or a cumulative bit rate available. Taking a selected application(s) at the computing device enables Wi-Fi networks to be ranked in a manner that is tailored to the selected application(s) and hence leads to an improved ranking of the Wi-Fi networks when compared to systems that simply list Wi-Fi networks based on signal strength alone.

FIG. 3B shows another example environment for enabling the improved sorting of Wi-Fi networks, in accordance with some embodiments of the disclosure. FIG. 3B shows the user interface of FIG. 3A but with the application PS Remote Play 310a selected. In this example, fewer Wi-Fi networks 312a-c are shown, based on the selection of the application PS Remote Play 310a. In this example, the Wi-Fi networks are re-ranked, with respect to the order shown in connection with FIG. 3A because the networks are ranked based on just the requirements of the PS Remote Play 310a application.

FIG. 3C shows another example environment for enabling the improved sorting of Wi-Fi networks, in accordance with some embodiments of the disclosure. FIG. 3C shows the user interface of FIG. 3A but with the application Messages 310e selected. In this example, the Wi-Fi networks 312a-e are shown in a different order from the order shown in FIG. 3A, based on the selection of the application Messages 310e. In this example, the Wi-Fi networks are re-ranked, with respect to the order shown in connection with FIGS. 3A and 3B because the networks are ranked based on just the requirements of the Messages 310e application.

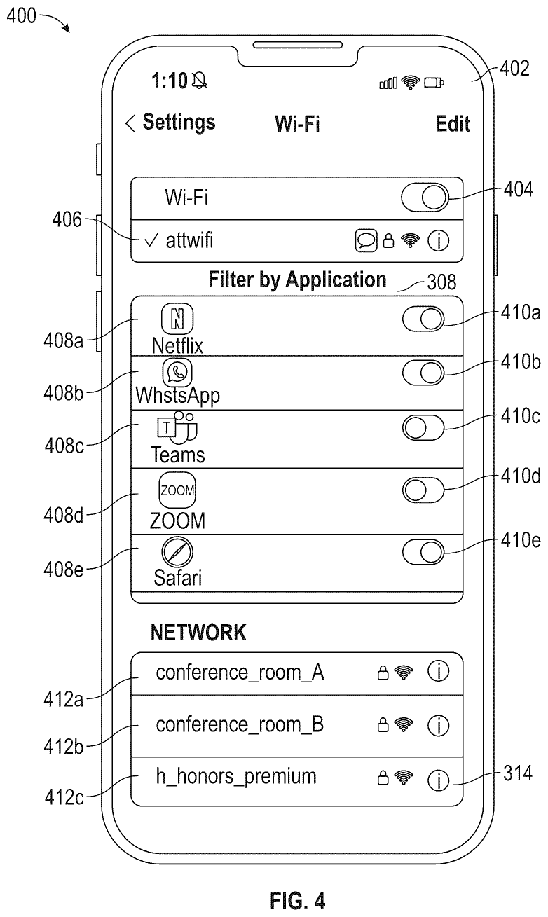

FIG. 4 shows another example environment for enabling the improved sorting of Wi-Fi networks, in accordance with some embodiments of the disclosure. The environment 400 comprises a GUI 402 for a computing device, such as a smartphone. The GUI 402 comprises a first user interface element 404 for turning a Wi-Fi connection on and off, and an indication 406 of the Wi-Fi network that the smartphone is connected to. In addition, the GUI 402 comprises a section for filtering Wi-Fi networks by application 408a-e. In this example, the applications are Netflix 408a, WhatsApp 408b, Teams 408c, Zoom 408d, Safari 408e. The section also comprises a plurality of corresponding user interface elements 410a-e that enable a user to select an application to filter the Wi-Fi networks by. In this example, one or more of the user interface elements 410a-e may be selected, generating ranking priorities for the Wi-Fi network based on the associated applications 408a-e. Each application may have different, or the same, network resources associated with it. The GUI 402 also indicates other Wi-Fi networks 412a-c that are available for connecting to and that are ordered based on the selected user interface elements 410a-e. In some examples, the applications may be ordered, ranked and/or prioritized by a network management app (such as based on historical application use; predicted application use; and/or foreground and/or background application functionality) and/or by input received from, for example, a user (e.g., an first input selecting a Netflix application, a second input selecting a Safari application and a third input selecting a WhatsApp application).

The computing device may constantly or periodically read broadcast beacon frames as the capacity and load changes on the Wi-Fi APs that are visible to the client, and it may generate a pop-up message for display on the computing device display that a different Wi-Fi AP that may provide better performance is available for a current application (such as video streaming) running in the foreground. In another example, a pop-up message may be generated for display on the computing device that a different Wi-Fi AP may provide better performance for an application that was recently closed, or shut down, on a computing device due to a lack of a Wi-Fi network resource for running that application. For example, an application, such as a Marriott Bonvoy application, may have been closed because a first Wi-Fi AP did not have enough bandwidth to run the application correctly. On detecting a Wi-Fi network with a greater bandwidth, a pop-up message may be generated for display indicating that a Wi-Fi network with a greater bandwidth is available. Furthermore, one or more applications running on the computing device may signal performance indicators to an underlying Wi-Fi manager or Wi-Fi device driver running on the computing device. These performance indicators may include a number of application layer timeouts, a number of corrupted video frames and/or an update time for an email inbox. Alternately, the application may translate parameters into guidance for a Wi-Fi device driver, such as “Switch to a better network if available,” or “Do not switch” (because the current performance is satisfactory). This guidance may be used by the Wi-Fi device driver to determine whether to switch to another Wi-Fi AP. Upon displaying the notification at the computing device, the computing device firmware and/or driver may initiate a join operation to the new candidate AP chosen by the client device. This may also be valid if an input to switch to an application that has lower traffic and/or bandwidth requirements is received, and this will more likely to happen if, for example, the current AP is a premium (e.g., a paid for) network. In this case, the computing device Wi-Fi manager may have a user-created configuration setting that prefers either certain networks, or a setting indicating a preference for a free Wi-Fi network over a premium (paid) Wi-Fi network.

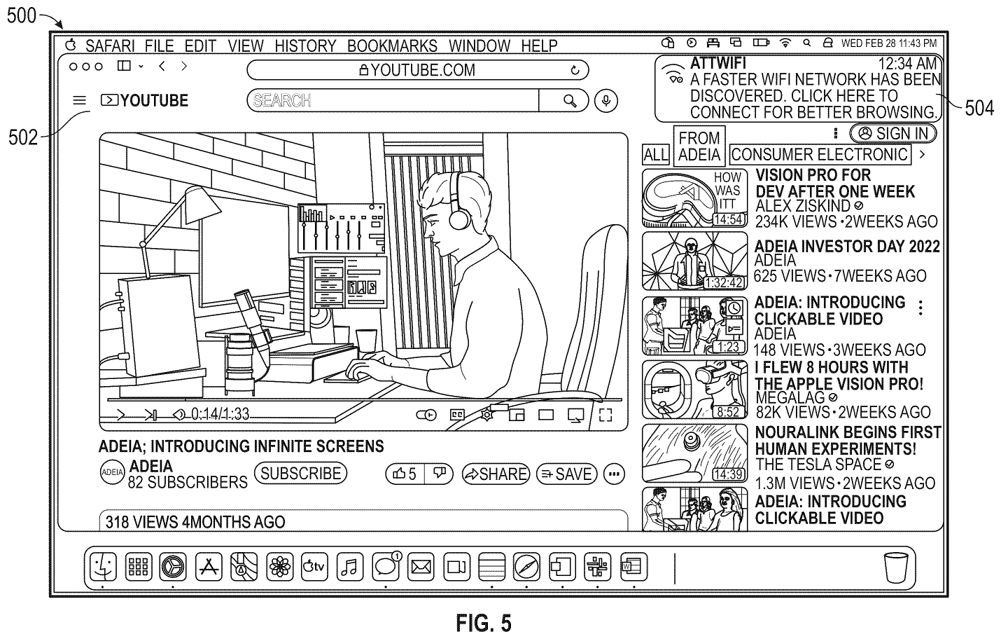

FIG. 5 shows another example environment for implementing the improved sorting of Wi-Fi networks, in accordance with some embodiments of the disclosure. The environment 500 comprises a computing device, such as a laptop, running a video streaming website 502, in this example YouTube. In this example, a notification 504 that “A faster Wi-Fi network has been discovered” is generated for output at the computing device. The notification comprises a selectable user interface element and, on receiving an input associated with the notification, the laptop may connect to the faster Wi-Fi network. In some examples, on detecting a Wi-Fi networks with one or more improved attributes is available, application features that were previously not available due to, for example, a relatively low bandwidth and/or a relatively high latency are enabled. In this example, the application features may be dependent on the capabilities of one or more detected Wi-Fi networks.

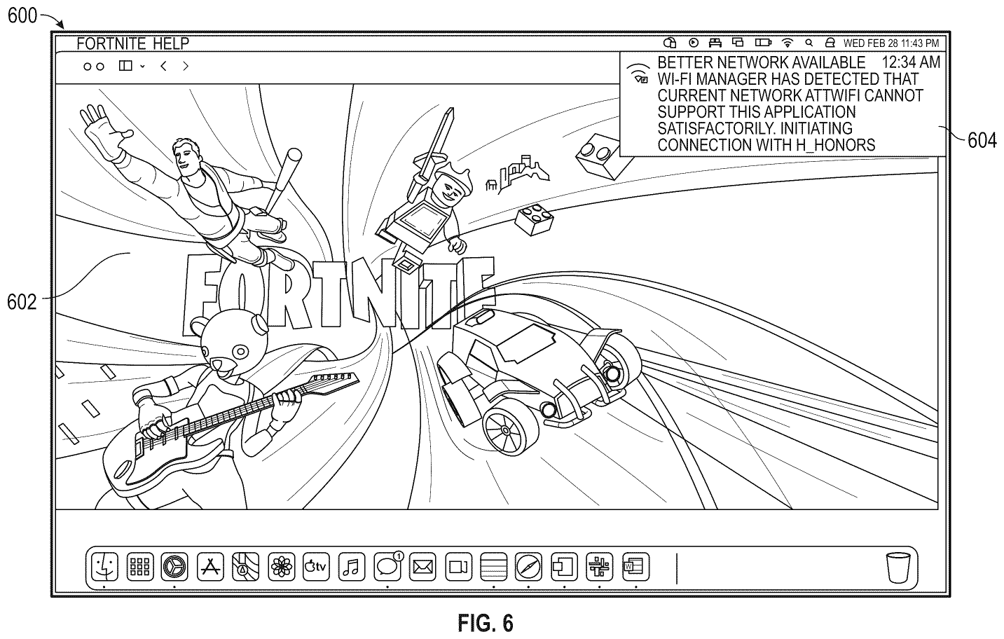

FIG. 6 shows another example environment for implementing the improved sorting of Wi-Fi networks, in accordance with some embodiments of the disclosure. The environment 600 comprises a computing device, such as a laptop, running a game 602, in this example “Fortnite.” In this example, a “Better network available” notification 604 is generated for output at the computing device. The notification states “Wi-Fi manager has detected that current network attwifi cannot support this application satisfactorily. Initiating connection with h_honors.” In this example, a Wi-Fi manager automatically detects the type of application running at the computing device and initiates a switch to a more suitable Wi-Fi network, for example, one that is ranked more highly based on the network resource, or resources, associated with the application as described, for example, in connection with the aforementioned FIGS.

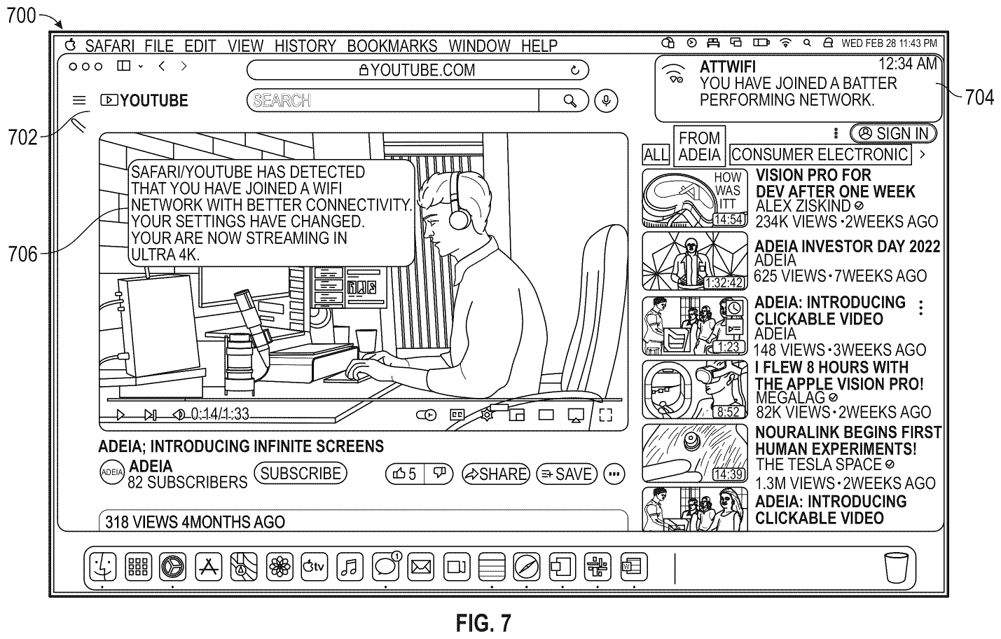

FIG. 7 shows another example environment for implementing the improved sorting of Wi-Fi networks, in accordance with some embodiments of the disclosure. The environment 700 comprises a computing device, such as a laptop, running a video streaming website 702, in this example YouTube. In this example, a first notification 704 that “You have joined a better-performing network” is generated for output at the computing device. For example, a Wi-Fi manager may automatically detect the type of application running at the computing device and initiates a switch to a more suitable Wi-Fi network, for example, one that is ranked more highly based on the network resource, or resources, associated with the application. A second notification 706 is also generated for output at the computing device. In this example, the notification reads “Safari/YouTube has detected that you have joined a Wi-Fi network with better connectivity. Your settings have changed. You are now streaming in Ultra 4K.” In this example, an application detects that the computing device is connected to a Wi-Fi network that is more suitable than a previously connected-to Wi-Fi network and changes an attribute, such as video quality, in response to the change in Wi-Fi network. This may be, for example, in response to an indication being transmitted from the operating system to the application. In some examples, this may be in response to an input changing a Wi-Fi network. In some examples, a Wi-Fi device driver may detect that an application cannot be supported with a desired quality of experience on a current Wi-Fi network, and a switch to another Wi-Fi network may be automatically initiated, for example, by the Wi-Fi device driver and/or the computing device.

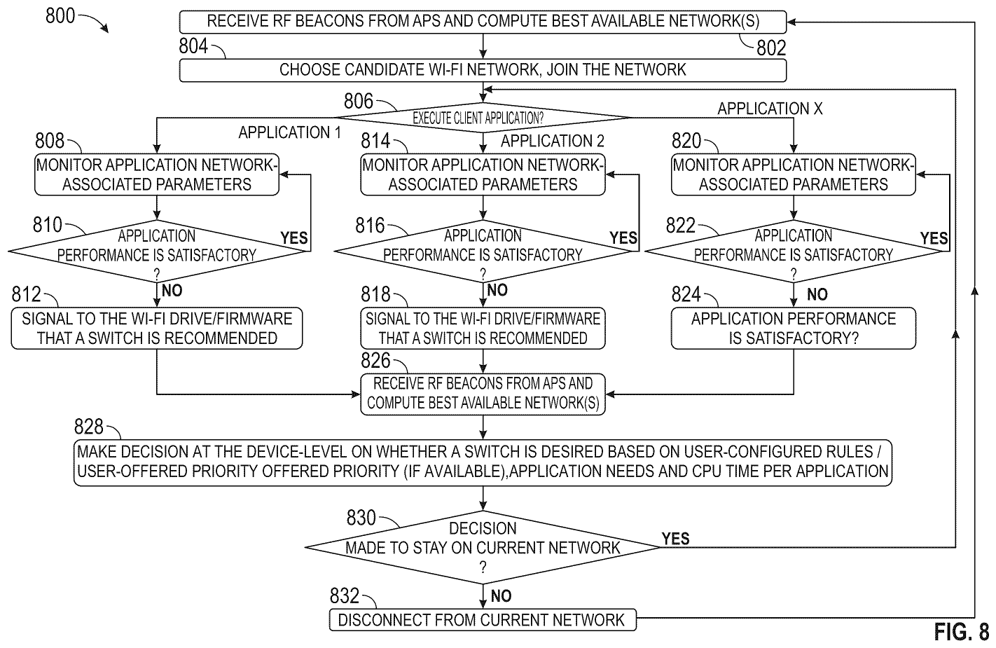

FIG. 8 shows a flowchart of illustrative steps involved in enabling the improved sorting of Wi-Fi networks, in accordance with some embodiments of the disclosure. Process 800 may be implemented, in whole or in part, on any of the aforementioned computing devices. In addition, one or more actions of the process 800 may be incorporated into or combined with one or more actions of any other processes or embodiments described herein. Process 800 may enable a computing device to monitor AP beacons and determine when to change a Wi-Fi network at the computing device. At 802, RF beacons from APs (such as Wi-Fi network APs) are received at a computing device, and a best available Wi-Fi network, or networks, is computed. In this example, at 804, a candidate Wi-Fi network is chosen, and the computing device joins the Wi-Fi network.

At 806, a plurality of client applications are executed and/or analyzed (Applications 1-X). In the present example, for Application 1, at 808, the network parameters associated with the application are monitored. At 810, it is determined whether the application performance through the connection to the candidate Wi-Fi network is satisfactory. If, at 810, it is determined that the application performance is satisfactory, the process loops back to step 808. If, at 810, it is determined that the application performance is not satisfactory, the process proceeds to step 812. At step 810, the determination may be measured by application level parameters such as a number of time-outs of a web page loading in a web browser application, and/or a number of times video buffering causes video playback to pause and/or freeze in a video streaming application. At step 812, a signal is transmitted to a Wi-Fi driver and/or firmware that a network switch is recommended, and the process proceeds to step 826. Similarly, for Application 2, at 814, the network parameters associated with the application are monitored. At 816, it is determined whether the application performance is satisfactory. If, at 816, it is determined that the application performance is satisfactory, the process loops back to step 814. If, at 816, it is determined that the application performance is not satisfactory, the process proceeds to step 818, where a signal is transmitted to a Wi-Fi driver and/or firmware that a network switch is recommended, and the process proceeds to step 826. Likewise, for Application X, at 820 the network parameters associated with the application are monitored. At 822, it is determined whether the application performance is satisfactory. If, at 822, it is determined that the application performance is satisfactory, the process loops back to step 820. If, at 822, it is determined that the application performance is not satisfactory, the process proceeds to step 824, where a signal is transmitted to Wi-Fi driver and/or firmware that a network switch is recommended, and the process proceeds to step 826. Corresponding steps are performed for all applications.

At 826, RF beacons are received from the APs, and the best available network, or networks, are computed. At 828, a decision is made at the computing device-level on whether a switch is desired based on user-configured rules and/or a user-offered priority (if available), application needs, and central processing unit (CPU) time per application. At 830, a decision is made whether to stay on the current Wi-Fi network. If, at 830, a decision is made to stay on the current Wi-Fi network, the process loops back to step 806. If, at 830, a decision is made to change the current Wi-Fi network, the process proceeds to step 832, where the computing device disconnects from the current Wi-Fi network, and the process loops around to step 802.

In an example, 802.11az localization and triangulation techniques may be leveraged to generate complex navigation and/or simple directional instructions to an AP that has better capacity and load parameters, but that AP (in some examples, despite belonging to the same Wi-Fi network) is farther away from the AP than this computing device can “hear,” because the AP is out of RF range of the computing device.

In another example, a beacon frame that is communicated as described above may also include information about whether an AP is using high-rate frames more than low-rate frames. In some examples, this may be represented via a single bit. If high-rate frames are being used, this may mean that an AP has efficient channel utilization, and this may be taken into account as a tie-breaker in terms of picking a Wi-Fi network if, for example, the rest of the parameters discussed above are equal or close.

In an example, the beacon frame that is discussed above may also include a retransmission percentage. A high retransmission rate may mean, for example, wasted channel time for this AP, and this may be taken into account as tie-breaker in terms of picking a Wi-Fi network if the rest of the parameters described above are equal or close.

In another example, an output notification may include a suggestion or availability to switch to a better resolution of a streamed video if a better Wi-Fi network is accepted to be joined. This notification may comprise a question or a switch to another media resolution on a content platform being used, such as an over-the-top application.

In an example, AP load information that is broadcast may also be transmitted to a cloud management interface. The cloud management interface may also record client computing device disconnections during high load situations. This may enable an administrator to see which network APs are very busy or subject to interference and hence may need to be supplemented by more APs. Furthermore, the administrator may also be able to inspect such APs in terms of age, since older APs may have limited processing power and memory, and thus, a Wi-Fi network administrator may base their decision of which APs to upgrade with newer equipment. Moreover, such data may also enable the administrator to sub-divide their network into several different SSIDs.

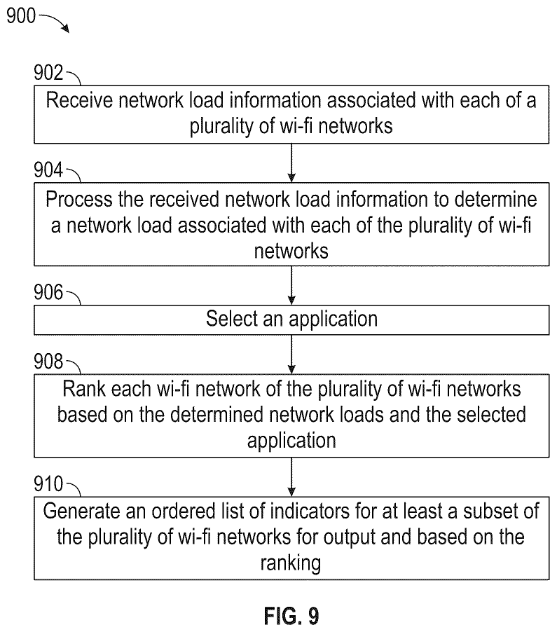

FIG. 9 shows another flowchart of illustrative steps involved in enabling the improved sorting of Wi-Fi networks, in accordance with some embodiments of the disclosure. Process 900 may be implemented, in whole or in part, on any of the aforementioned computing devices. In addition, one or more actions of the process 900 may be incorporated into or combined with one or more actions of any other processes or embodiments described herein. At 902, network load information associated with a plurality of Wi-Fi networks is received. At 904, the received network load information is processed to determine a network load associated with each of the plurality of Wi-Fi networks. At 906, an application is selected. At 908, each Wi-Fi network of the plurality of Wi-Fi networks is ranked based on the determined network loads and the selected application. At 910, an ordered list of indicators for at least a subset of the plurality of Wi-Fi networks is generated for output and based on the ranking.

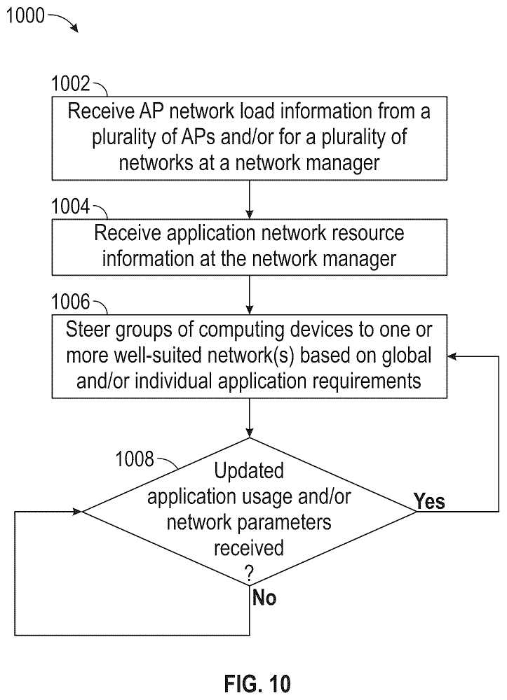

FIG. 10 shows another flowchart of illustrative steps involved in enabling the improved sorting of Wi-Fi networks, in accordance with some embodiments of the disclosure. Process 1000 may be implemented, in whole or in part, on any of the aforementioned computing devices. In addition, one or more actions of the process 1000 may be incorporated into or combined with one or more actions of any other processes or embodiments described herein. At 1002, a network manager receives AP network load information from a plurality of APs and/or for a plurality of networks. At 1004, the network manager receives application network resource information. At 1006, the network manager then uses this received information to steer groups of computing devices to one or more well-suited network(s) based on global and/or individual application usage and/or requirements. At 1008, it is optionally determined whether updated application usage and/or network parameters have been received. If updated parameters have been received, then the process loops back to 1006. If updated parameters have not been received, then the process ends at 1010. In some examples, the network manager may dynamically change AP and/or network parameters based on application usage and/or requirements for a plurality of application and/or a plurality of computing devices. The changing of AP and/or network parameters may include changing the number of clients that are allowed to connect to an AP and for what purposes a client is allowed to connect to an AP. For example, the network manager may increase the number of clients allowed to connect an AP, but for limited purposes, such as just for a particular application and for limited functionality of the particular application (e.g., for a ticketing application to request and receive a mobile ticket for a specific event associated with the network and/or AP, and not to search and purchase tickets to other events).

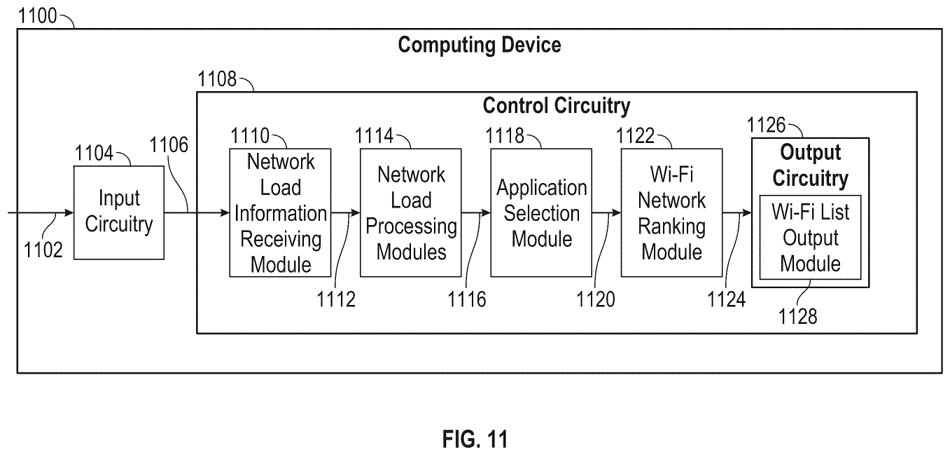

FIG. 11 shows a block diagram representing components of a computing device and dataflow therebetween for enabling the improved sorting of Wi-Fi networks, in accordance with some embodiments of the disclosure. Computing device 1100 comprises input circuitry 1104, control circuitry 1108 and output circuitry 1126. The computing device 1100 may be, for example, a smartphone, a tablet and/or a smart television. Control circuitry 1108 may be based on any suitable processing circuitry and comprises control circuits and memory circuits, which may be disposed on a single integrated circuit or may be discrete components and processing circuitry. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores). In some embodiments, processing circuitry may be distributed across multiple separate processors or processing units, for example, multiple of the same type of processing units (e.g., two Intel Core i9 processors) or multiple different processors (e.g., an Intel Core i5 processor and an Intel Core i7 processor) and/or a system on a chip (e.g., a Qualcomm Snapdragon 888). Some control circuits may be implemented in hardware, firmware, or software.

First input is received 1102 by the input circuitry 1104. The input circuitry 1104 is configured to receive inputs related to a computing device. For example, this may comprise instructions received via another computing device. The input circuitry 1104 transmits 1106 the user input to the control circuitry 1108.

The control circuitry 1108 comprises a network load information receiving module 1110, a network load processing module 1114, an application selection module 1118, a Wi-Fi network ranking module 1122 and output circuitry 1126 comprising a Wi-Fi list output module 1128. The first input is transmitted 1106 to the network load information receiving module 1110, where network load information associated with a plurality of Wi-Fi networks is received. The received network load information is transmitted 1112 to the network load processing module 1114, where the received network load information is processed. The processed network load information is transmitted 1116 to the application selection module 1118, where an application is selected. The processed network load information and an indication of the selected application are transmitted 1120 to the Wi-Fi network ranking module 1122, where the Wi-Fi networks are ranked. An indication of the Wi-Fi networks and their ranking is transmitted 1124 to the Wi-Fi list output module, where a ranked list of Wi-Fi networks is generated for output.

In some examples, any of the aforementioned Wi-Fi networks may be any other wireless network that is receivable by a computing device. For example, a wireless network may be a cellular and/or a satellite network. In some examples, a computing device may enable the ordering of different cellular and/or satellite networks in the manner described above in connection with Wi-Fi networks. In other examples, a computing device may enables the prioritization of different available networks such as, Wi-Fi, cellular and/or satellite networks. For example, a satellite network may have preferable characteristics when compared to a Wi-Fi network and cellular network, and the satellite network may be ranked more highly than the Wi-Fi and cellular networks.

The processes described above are intended to be illustrative and not limiting. One skilled in the art would appreciate that the steps of the processes discussed herein may be omitted, modified, combined, and/or rearranged, and any additional steps may be performed without departing from the scope of the disclosure. More generally, the above disclosure is meant to be illustrative and not limiting. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

1. A method comprising:
receiving, at a computing device, network load information associated with each of a plurality of Wi-Fi networks;
processing the received network load information to determine a network load associated with each of the plurality of Wi-Fi networks;
selecting an application at the computing device;
ranking, based on the determined network loads and the selected application, each Wi-Fi network of the plurality of Wi-Fi networks; and
generating, for output and based on the ranking, an ordered list of indicators for at least a subset of the plurality of Wi-Fi networks.

2. The method of claim 1, wherein the network load information is received within a beacon management frame associated with a Wi-Fi network.

3. The method of claim 2, wherein the beacon management frame further comprises an indication of whether an access point associated with a Wi-Fi network is using high-rate frames more than low-rate frames.

4. The method of claim 2, wherein the beacon management frame further comprises an indication of a retransmission percentage.

5. The method of claim 1, wherein the network load information comprises at least one of: a maximum number of connected devices, a current number of connected devices, a temporal channel loading, an available bit rate, a processor utilization, or memory utilization.

6. The method of claim 5, wherein the temporal channel loading comprises an indication of the percentage of time for which a channel is busy.

7. The method of claim 5, wherein the available bit rate comprises a maximum bit rate available to the computing device.

8. The method of claim 1, wherein:
selecting the application at the computing device further comprises selecting a plurality of applications running or scheduled to be run at the computing device;
the method further comprises determining, for at least a subset of the respective running or scheduled-to-be-run applications, a network resource associated with each of the subset of running or scheduled-to-be-run applications; and
wherein ranking each Wi-Fi network of the plurality of Wi-Fi networks further comprises ranking the each Wi-Fi network based on the determined network resources.

9. The method of claim 1, wherein:
the method further comprises receiving, at the computing device, an input associated with selecting an activity; and
ranking the plurality of Wi-Fi networks further comprises ranking the plurality of Wi-Fi networks based on the selected activity.

10. The method of claim 1, wherein:
the network load information is received at a first time;
selecting the application further comprises selecting an application running at the computing device;
the subset of the plurality of Wi-Fi networks is a first subset; and
the method further comprises:
receiving updated network load information for at least a second subset of the Wi-Fi networks;
identifying a Wi-Fi network that the computing device is connected to;
identifying that a different Wi-Fi network may be more suitable for the application running at the computing device; and
generating, for output, a notification identifying the different Wi-Fi network.

11. The method of claim 10, wherein:
the running application is a content streaming application that is streaming a content item at a first resolution;
the notification further comprises a user interface element for switching to the different Wi-Fi network; and
the method further comprises, in response to receiving an input with the user interface element:
switching to the different Wi-Fi network; and
requesting, via the content streaming application, the content item at a second resolution that is higher than the first resolution.

12. The method of claim 1, wherein the method further comprises:
receiving an indication of a plurality of access points associated with a Wi-Fi network;
receiving network load information associated with at least a subset of the plurality of access points associated with the Wi-Fi network;
calculating a network load associated with each of the subset of the plurality of access points associated with the Wi-Fi network;
identifying that a first network load associated with a first access point that is in range of the computing device is higher than a second network load associated with a second access point that is out of range of the computing device;
identifying, based on localization and triangulation of the computing device with respect to the first access point, a location of the computing device; and
generating, for output and based on the location of the computing device, directions to the second access point.

13. A system comprising:
input/output circuitry configured to:
receive, at a computing device, network load information associated with each of a plurality of Wi-Fi networks;
processing circuitry configured to:
process the received network load information to determine a network load associated with each of the plurality of Wi-Fi networks;
select an application at the computing device;
rank, based on the determined network loads and the selected application, each Wi-Fi network of the plurality of Wi-Fi networks; and
generate, for output and based on the ranking, an ordered list of indicators for at least a subset of the plurality of Wi-Fi networks.

14. The system of claim 13, wherein the network load information is received within a beacon management frame associated with a Wi-Fi network.

15. The system of claim 14, wherein the beacon management frame further comprises an indication of whether an access point associated with a Wi-Fi network is using high-rate frames more than low-rate frames.

16. The system of claim 14, wherein the beacon management frame further comprises an indication of a retransmission percentage.

17. The system of claim 13, wherein the network load information comprises at least one of: a maximum number of connected devices, a current number of connected devices, a temporal channel loading, an available bit rate, a processor utilization, or memory utilization.

18. The system of claim 17, wherein the temporal channel loading comprises an indication of the percentage of time for which a channel is busy.

19. The system of claim 17, wherein the available bit rate comprises a maximum bit rate available to the computing device.

20. The system of claim 13, wherein:
the processing circuitry configured to select the application at the computing device is further configured to select a plurality of applications running or scheduled to be run at the computing device;
the processing circuitry is further configured to determine, for at least a subset of the respective running or scheduled-to-be-run applications, a network resource associated with each of the subset of running or scheduled-to-be-run applications; and
the processing circuitry configured to rank each Wi-Fi network of the plurality of Wi-Fi networks is further configured to rank the each Wi-Fi network based on the determined network resources.

21-60. (canceled)
